(19) United States
(12) Patent Application Publication
(10) Pub. No.: US 2024/0393095 A1
(43) Pub. Date: Nov. 28, 2024

(54) Picket Height Guide

(71) Applicant: Jig Tool LLC, Hernando, MS (US)

(72) Inventor: Brant A. Quinton, Knoxville, TN (US)

(73) Assignee: Jig Tool LLC, Hernando, MS (US)

(21) Appl. No.: 18/324,312

(22) Filed: May 26, 2023

(51) Int. Cl. G01B 3/32

(52) U.S. Cl. CPC G01B 3/32; E04H 17/143

(57) ABSTRACT

A picket height guide system having a rail guide with a rail tine at a first end and a first guide tine at a second end, where the rail tine and the first guide tine are separated by a desired distance, and a picket guide having a picket tine at a first end and second guide tine at a second end, where the picket tine and the second guide tine are immediately adjacent one another.

### FIELD

This invention relates to the field of fencing. such as residential and commercial fences. More particularly, this invention relates to a guide for setting the height of pickets in a fence.

### INTRODUCTION

Picket fences are popular for enclosing yards in the residential market, and in other markets. One method of constructing a picket fence involves setting substantially vertical posts in the ground at desired distances, putting up two or more generally horizontal cross-rails between each adjacent set of posts, and then affixing pickets in a substantially vertical orientation onto the rails.

Most people prefer the pickets to be disposed with the tops of the pickets at a uniform height. It is often difficult to set the pickets in this orientation just by judging them by sight, and it is very time consuming to measure the position of each picket to ensure that they are at the same height.

Thus, one method that has been used to speed the construction process is to affix the pickets to the rails, such as with nails, brads, adhesive, or screws, without much concern as to their relative height, one to another, and then come back later and either snap a chalk line and then cut them all off, or just cut them all off at once without and chalk line and hope for the best.

Unfortunately, these various methods either take too much time or produce unsatisfactory results.

What is needed, therefore, is a method and apparatus for setting picket heights on a fence that tend to reduce issues such as those introduced above, at least in part.

### SUMMARY

The above and other needs are met by a picket height guide system having a rail jig with a rail tine at a first end and a first guide tine at a second end, where the rail tine and the first guide tine are separated by a desired distance, and a picket jig having a picket tine at a first end and second guide tine at a second end, where the picket tine and the second guide tine are immediately adjacent one another.

In various embodiments according to this aspect of the disclosure, a guide rail that at a first end engages the first guide tine of the rail jig, and at a second end engages the second guide tine of the picket jig. In some embodiments, the rail tine of the rail jig engages a fence rail and the picket tine of the picket jig engages a picket that is fastened to a fence. In some embodiments, the desired distance substantially equals a desired height above the fence rail of a picket that is to be fastened to the fence. In some embodiments, attachment points are disposed in each of the guide tines on the rail jig and the guide tines on the picket jig, where the attachment points are adapted for attachment of the rail jig and the picket jig to a guide rail. In some embodiments, screw holes are disposed in each of the guide tines on the rail jig and the guide tines on the picket jig, where the screw holes are adapted for attachment of the rail jig and the picket jig to a guide rail. In some embodiments, the guide jig is marked with a first color, and the picket jig is marked with a second color, and the first color is different from the second color. In some embodiments, the guide jig and the picket jig are each formed of at least one of a metal and a thermoplastic resin.

### DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a perspective view of a rail jig portion of an apparatus according to an embodiment of the present disclosure.

FIG. 2 is a perspective view of a picket jig portion of an apparatus according to an embodiment of the present disclosure.

FIG. 3 is a first perspective view of a method for using the rail jig and the picket jig to set the heights of pickets according to an embodiment of the present disclosure.

FIG. 4 is a second perspective view of the method for using the rail jig and the picket jig to set the heights of pickets according to an embodiment of the present disclosure.

### DESCRIPTION

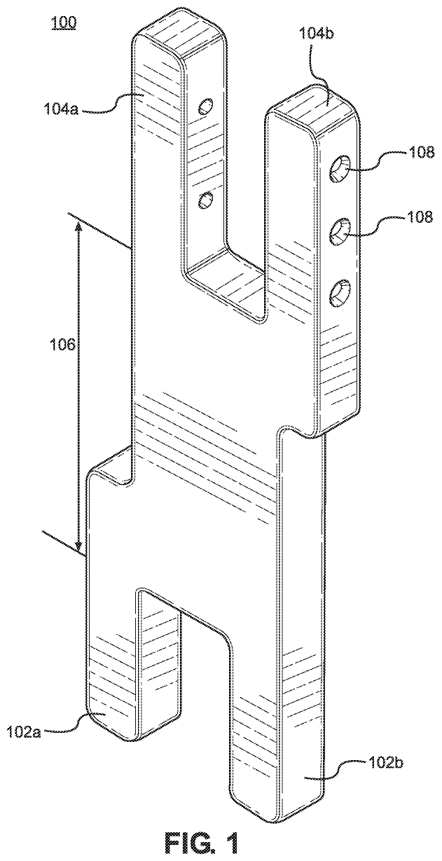

With reference now to FIG. 1, there is depicted a rail jig 100 according to an embodiment of the present disclosure. In the embodiment as depicted, the rail jig 100 includes rail tines 102a and 102b at one end of the rail jig 100, and guide tines 104a and 104b disposed at the other end of the rail jig 100. The rail tines 102a and 102b are spaced apart from the guide tines 104a and 104b by a desired distance 106. Some embodiments include attachment points 108, such as screw holes, whereby a guide beam 302 (as depicted and described in later figures) can be releasably attached to the rail jig 100.

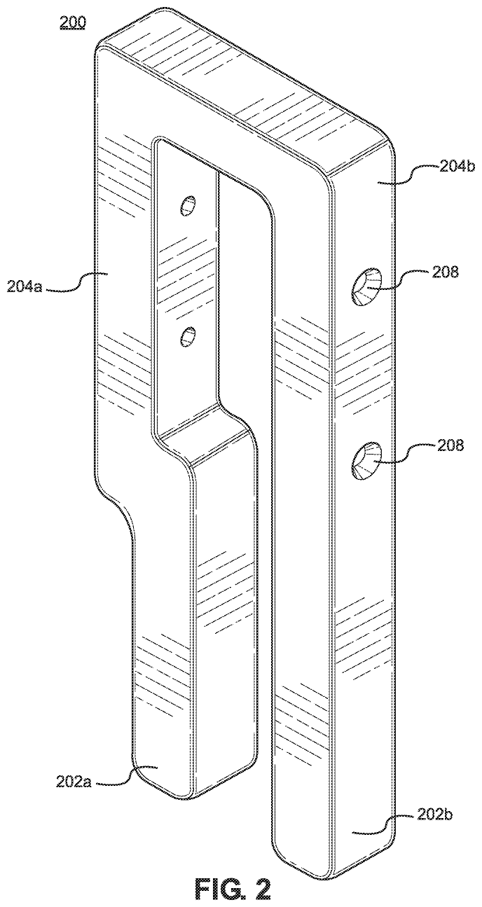

With reference now to FIG. 2, there is depicted a picket jig 200 according to an embodiment of the present disclosure. In the embodiment as depicted, the picket jig 200 includes picket tines 202a and 202b at one end of the picket jig 200, and guide tines 204a and 204b disposed at the other end of the picket jig 200. The picket tines 202a and 202b are not spaced apart from the guide tines 204a and 204b at all, but are immediately adjacent one another. Some embodiments include attachment points 208, such as screw holes, whereby the guide beam 302 can be releasably attached to the rail jig 100.

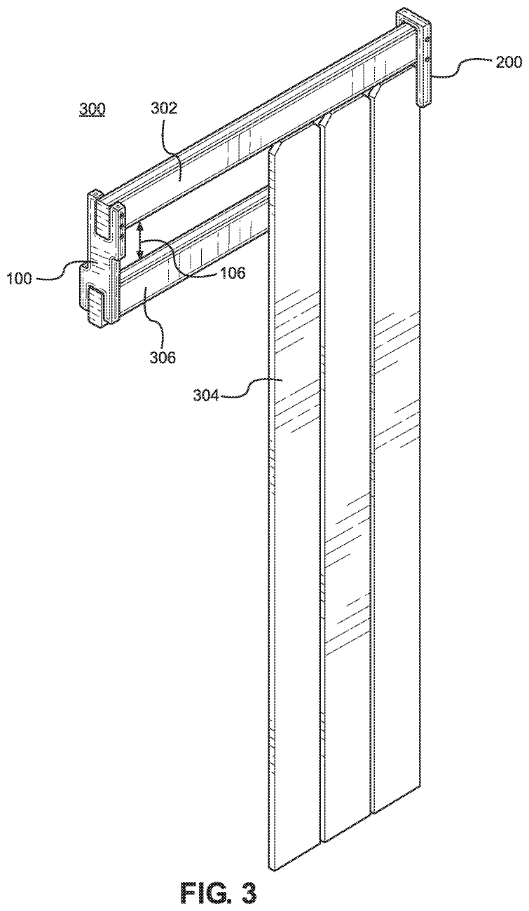

With reference now to FIG. 3, there is depicted a portion of a fence 300, embodying a method for using the rail jig 100 and the picket jig 200 to set the heights of pickets 304 according to an embodiment of the present disclosure. As can be seen, the guide beam 302 is attached at distal ends to both the rail jig 100 and the picket jig 200 using the guide tines 104a and 104b on the rail jig 100 and the guide tines 204a and 204b on the picket jig 200.

The rail jig 100 is placed with the rail tines 102a and 102b engaging a rail 306 and the picket jig 200 is placed with the picket tines 204a and 204b engaging previously placed pickets 304. This arrangement places the entirety of the length of the guide beam 302 at the desired height 106 above the top rail 306 of the fence 300. In this manner, each new picket 304, as it is placed, can be immediately set at the desired height 106.

In some embodiments, the guide tines 104a and 104b on the rail jig 100 are offset from the rail tines 102a and 102b on the rail jig 100, such that the guide rail 302 is offset by some amount from the existing rail 306 to which the pickets 304 are affixed. In this manner, a new picket 304, which is to be affixed to the fence at a desired height 106 above the rail 306, can be quickly set into place with the top of the new picket 304 abutting the bottom of the guide rail 302. In some embodiments, the offset between the guide tines 104a and 104b on the rail jig 100 are offset from the rail tines 102a and 102b on the rail jig 100 by at least the thickness of the tines 304.

In some embodiments, the rail jig 100 and the picket jig 200 are formed of a resilient material, such as metal or a relatively durable thermoplastic resin. In some embodiments the rail jig 100 and the picket jig 200 are each marked in some way, such that they are easily distinguishable one from another, so that they can be readily identified in a construction setting. In some embodiments, the markings are different colors for each of the rail jig 100 and the picket jig 200. In some embodiments, the markings are different indicia that are placed on each of the rail jig 100 and the picket jig 200. In some embodiments, the markings are different surface textures that are applied to each of the rail jig 100 and the picket jig 200.

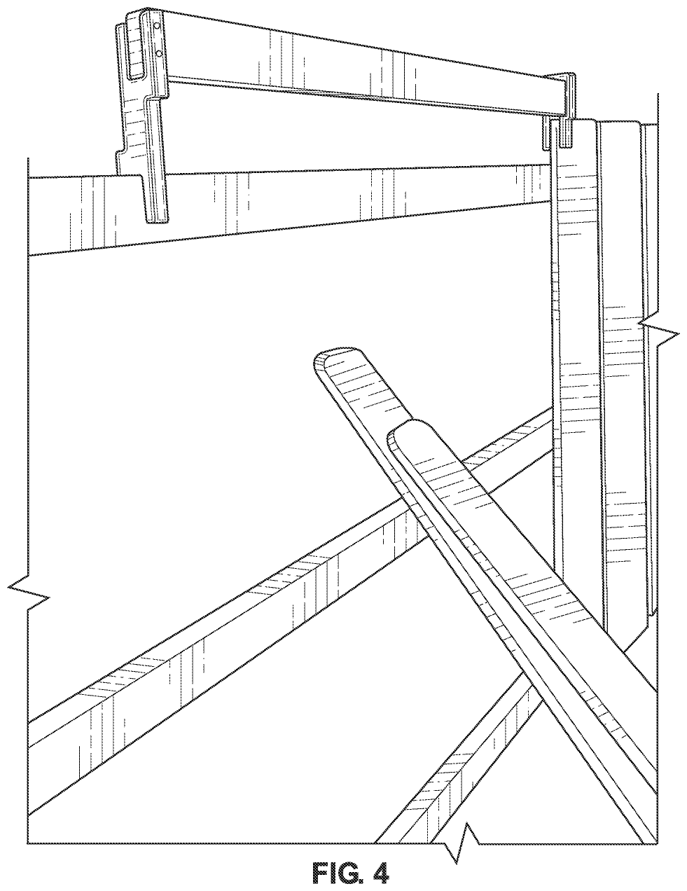

FIG. 4 depicts an embodiment of the use of the rail jig 100 and the picket jig 200 that is similar to that as depicted in FIG. 3.

As used herein, the phrase “at least one of A, B, and C” means all possible combinations of none or multiple instances of each of A, B, and C, but at least one A, or one B, or one C. For example, and without limitation: A×1, A×2+B×1, C×2, A×1+B×1+C×1, A×7+B×12+C×113. It does not mean A×0+B×0+C×0.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly. legally, and equitably entitled.

1. A picket height guide system comprising:
a rail jig having a rail tine at a first end and a first guide tine at a second end, where the rail tine and the first guide tine are separated by a desired distance, and
a picket jig having a picket tine at a first end and second guide tine at a second end, where the picket tine and the second guide tine are immediately adjacent one another.

2. The picket height guide system of claim 1, further comprising a guide rail that at a first end engages the first guide tine of the rail jig, and at a second end engages the second guide tine of the picket jig.

3. The picket height guide system of claim 2, wherein the rail tine of the rail jig engages a fence rail and the picket tine of the picket jig engages a picket that is fastened to a fence.

4. The picket height guide system of claim 3, wherein the desired distance substantially equals a desired height above the fence rail of a picket that is to be fastened to the fence.

5. The picket height guide system of claim 1, further comprising attachment points disposed in each of the guide tines on the rail jig and the guide tines on the picket jig, the attachment points adapted for attachment of the rail jig and the picket jig to a guide rail.

6. The picket height guide system of claim 1, further comprising screw holes disposed in each of the guide tines on the rail jig and the guide tines on the picket jig, the screw holes adapted for attachment of the rail jig and the picket jig to a guide rail.

7. The picket height guide system of claim 1, wherein the guide jig is marked with a first color, and the picket jig is marked with a second color, and the first color is different from the second color.

8. The picket height guide system of claim 1, wherein the guide jig and the picket jig are each formed of at least one of a metal and a thermoplastic resin.

9. A picket height guide system comprising:
a rail jig having a rail tine at a first end and a first guide tine at a second end, where the rail tine and the first guide tine are separated by a desired distance,
a picket jig having a picket tine at a first end and second guide tine at a second end, where the picket tine and the second guide tine are immediately adjacent one another, and
a guide rail that at a first end engages the first guide tine of the rail jig, and at a second end engages the second guide tine of the picket jig.

10. The picket height guide system of claim 9, wherein the rail tine of the rail jig engages a fence rail and the picket tine of the picket jig engages a picket that is fastened to a fence.

11. The picket height guide system of claim 10, wherein the desired distance substantially equals a desired height above the fence rail of a picket that is to be fastened to the fence.

12. The picket height guide system of claim 9, further comprising attachment points disposed in each of the guide tines on the rail jig and the guide tines on the picket jig, the attachment points adapted for attachment of the rail jig and the picket jig to a guide rail.

13. The picket height guide system of claim 9, further comprising screw holes disposed in each of the guide tines on the rail jig and the guide tines on the picket jig, the screw holes adapted for attachment of the rail jig and the picket jig to a guide rail.

14. The picket height guide system of claim 9, wherein the guide jig is marked with a first color, and the picket jig is marked with a second color, and the first color is different from the second color.

15. The picket height guide system of claim 1, wherein the guide jig and the picket jig are each formed of at least one of a metal and a thermoplastic resin.

16. A picket height guide system comprising:
a rail jig having a rail tine at a first end and a first guide tine at a second end, where the rail tine and the first guide tine are separated by a desired distance,
a picket jig having a picket tine at a first end and second guide tine at a second end, where the picket tine and the second guide tine are immediately adjacent one another, and
a guide rail that at a first end engages the first guide tine of the rail jig, and at a second end engages the second guide tine of the picket jig,
wherein the rail tine of the rail jig engages a fence rail and the picket tine of the picket jig engages a picket that is fastened to a fence.

17. The picket height guide system of claim 16, wherein the desired distance substantially equals a desired height above the fence rail of a picket that is to be fastened to the fence.

18. The picket height guide system of claim 16, further comprising screw holes disposed in each of the guide tines on the rail jig and the guide tines on the picket jig, the screw holes adapted for attachment of the rail jig and the picket jig to a guide rail.

19. The picket height guide system of claim 16, wherein the guide jig is marked with a first color, and the picket jig is marked with a second color, and the first color is different from the second color.

20. The picket height guide system of claim 16, wherein the guide jig and the picket jig are each formed of at least one of a metal and a thermoplastic resin.
